(19) United States
(12) Patent Application Publication
(10) Pub. No.: US 2026/0071088 A1
(43) Pub. Date: Mar. 12, 2026

(54) Treatment Liquid, Ink Set, And Recording Method

(71) Applicant: SEIKO EPSON CORPORATION, Tokyo (JP)

(72) Inventors: Kentaro HARA, Shiojiri (JP); Sena GOZU, Shiojiri (JP); Shun SUZUKI, Shiojiri (JP); Jun ITO, Shimosuwa (JP)

(21) Appl. No.: 19/320,428

(22) Filed: Sep. 5, 2025

(30) Foreign Application Priority Data
Sep. 6, 2024 (JP) 2024-154021

(51) Int. Cl. C09D 11/54; C08K 5/09; C08K 5/19; C09D 7/60; C09D 11/32

(52) U.S. Cl. CPC C09D 11/54; C08K 5/09; C08K 5/19; C09D 7/60; C09D 11/32

(57) ABSTRACT

An aqueous treatment liquid to be used for recording on a recording medium that is an absorbent recording medium together with an ink jet ink composition containing a coloring material includes an aggregating agent and a sugar alcohol that is solid as a simple substance at normal temperature, in which when a 50 mass % aqueous solution of the sugar alcohol that is solid as a simple substance at normal temperature and that is contained in the treatment liquid is allowed to stand at 25° C. and 95% RH for 7 days, a mass change ratio before and after standing (after standing/before standing) is 120% or less.

The present application is based on, and claims priority from JP Application Serial Number 2024-154021, filed Sep. 6, 2024, the disclosure of which is hereby incorporated by reference herein in its entirety.

### BACKGROUND

### 1. Technical Field

The present disclosure relates to a treatment liquid, an ink set, and a recording method.

### 2. Related Art

Ink jet recording methods enable recording of high-definition images and have been rapidly developed in various fields. In addition to development of ink for use in ink jet recording, recording apparatuses and recording methods have been widely studied. For example, JP-A-2016-068306 describes the use of a treatment liquid for the purpose of enhancing the color developability of an ink jet ink composition. JP-A-2016-068306 indicates that suppression of penetration of the ink jet ink composition into a recording medium by the treatment liquid is one cause of the improvement in color developability.

However, when the treatment liquid is used, water contained in the treatment liquid adheres to the recording medium. As a result, the recording medium may curl due to the water in the treatment liquid. In addition, when the treatment liquid is used together with ink, the amount of water adhering to the recording medium increases, and particularly in the case of an absorbent recording medium, an increase in curling of a recorded material may occur.

### SUMMARY

A treatment liquid according to an aspect of the present disclosure is an aqueous treatment liquid to be used for recording on a recording medium that is an absorbent recording medium together with an ink jet ink composition containing a coloring material, the treatment liquid containing an aggregating agent and a sugar alcohol that is solid as a simple substance at normal temperature, in which when a 50 mass % aqueous solution of the sugar alcohol that is solid as a simple substance at normal temperature and that is contained in the treatment liquid is allowed to stand at 25° C. and 95% RH for 7 days, a mass change ratio before and after standing (after standing/before standing) is 120% or less.

An ink set according to an aspect of the present disclosure includes the treatment liquid described above and an ink jet ink composition.

A recording method according to an aspect of the present disclosure is performed using the treatment liquid described above and an ink jet ink composition, and includes attaching the treatment liquid to a recording medium that is an absorbent recording medium, and ejecting the ink jet ink composition from an ink jet head to attach the ink jet ink composition to the recording medium.

### BRIEF DESCRIPTION OF THE DRAWINGS

FIG. 1 is a conceptual diagram illustrating primary curling.

FIG. 2 is a conceptual diagram illustrating secondary curling.

FIG. 3 is a schematic cross-sectional view of a recording apparatus capable of being used in a recording method according to an embodiment.

FIG. 4 is Table 1 showing treatment liquid compositions and evaluation results of Examples.

FIG. 5 is Table 2 showing treatment liquid compositions and evaluation results of Examples and Comparative Examples.

### DESCRIPTION OF EMBODIMENTS

An embodiment of the present disclosure will be described below. The embodiment described below describes an example of the present disclosure. The present disclosure is not limited to the following embodiment, and also includes various modifications that are implemented without changing the spirit of the present disclosure. It should be noted that not all configurations described below are essential configurations of the present disclosure.

### 1. Treatment Liquid

A treatment liquid according to the present embodiment is an aqueous treatment liquid to be used for recording on a recording medium that is an absorbent recording medium together with an ink jet ink composition containing a coloring material. In addition, the treatment liquid according to the present embodiment contains an aggregating agent and a sugar alcohol that is solid as a simple substance at normal temperature. When a 50 mass % aqueous solution of the sugar alcohol that is solid as a simple substance at normal temperature and that is contained in the treatment liquid is allowed to stand at 25° C. and 95% RH for 7 days, the mass change ratio before and after the standing (after standing/before standing) is 120% or less. The ink jet ink composition containing the coloring material will be described later.

### 1.1. Aggregating Agent

The treatment liquid contains an aggregating agent which aggregates components of the ink jet ink composition (ink). The aggregating agent has an action of reacting with components such as the coloring material included in the ink and resin particles which may be included in the ink and thereby aggregating the coloring material and the resin particles. The degree of aggregation of the coloring material and the resin particles caused by the aggregating agent varies depending on the kinds of aggregating agent, coloring material, and resin particles, and can be adjusted. In addition, the aggregating agent can aggregate the coloring material and the resin particles by reacting with the coloring material and the resin particles included in the ink. For example, such aggregation makes it possible to enhance color development of the coloring material, enhance fixing properties of the resin particles, and/or enhance the viscosity of the ink.

Although the aggregating agent is not particularly limited, examples thereof include a metal salt, an inorganic acid, an organic acid, and a cationic compound, and as the cationic compound, a cationic resin (cationic polymer), a cationic surfactant, and the like may be used. Among these, a polyvalent metal salt is preferable as the metal salt.

The polyvalent metal salt is a compound composed of a divalent or higher valent metal ion and an anion. Examples of the divalent or higher valent metal ion include ions of calcium, magnesium, copper, nickel, zinc, barium, aluminum, titanium, strontium, chromium, cobalt, and iron. Among the metal ions constituting these polyvalent metal salts, at least one of a calcium ion and a magnesium ion is preferable because the aggregability of the components of the ink is excellent. That is, the polyvalent metal salt is preferably at least one of a calcium salt and a magnesium salt, and more preferably a calcium salt.

Examples of the anion constituting the polyvalent metal salt include an inorganic ion or an organic ion. That is, the polyvalent metal salt in the present disclosure is formed of an inorganic ion or an organic ion and a polyvalent metal. Examples of the inorganic ion include a chlorine ion, a bromine ion, an iodine ion, a nitrate ion, a sulfate ion, and a hydroxide ion. Examples of the organic ion include an organic acid ion such as a carboxylic acid ion. The polyvalent metal salt is more preferably an inorganic salt, and for example, calcium nitrate, magnesium sulfate, and the like are preferable, and calcium nitrate is further preferable. When the polyvalent metal salt is used, color development of the ink jet ink composition used together can be further improved.

The polyvalent metal compound is preferably an ionic polyvalent metal salt. In particular, the polyvalent metal salt is preferably a magnesium salt or a calcium salt, because stability of the treatment liquid is further improved. A calcium salt is particularly preferable. A counter ion of the polyvalent metal may be any of an inorganic acid ion and an organic acid ion.

Specific examples of the polyvalent metal salt include calcium carbonate such as heavy calcium carbonate and light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium formate, calcium acetate, magnesium acetate, and aluminum acetate. These polyvalent metal salts may be used alone or in combination of two or more thereof.

Among these, since sufficient solubility in water can be ensured, and residual marks of the treatment liquid are reduced (marks are made less noticeable), at least any one of calcium formate, magnesium sulfate, calcium nitrate, and calcium chloride is preferable, and at least one of calcium formate and calcium nitrate is more preferable. These metal salts may have water of hydration in a raw material form.

Examples of the metal salt other than the polyvalent metal salt include monovalent metal salts such as a sodium salt and a potassium salt, for example, sodium sulfate and potassium sulfate.

Preferable examples of the organic acid include poly(meth)acrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidonecarboxylic acid, pyronecarboxylic acid, pyrrolecarboxylic acid, furancarboxylic acid, pyridinecarboxylic acid, coumalic acid, thiophene carboxylic acid, nicotinic acid, derivatives of these compounds, and salts thereof. The organic acid may be used alone or in combination of two or more thereof. Salts of organic acids that are metal salts are included in the above-mentioned metal salt.

Examples of the inorganic acid include sulfuric acid, hydrochloric acid, nitric acid, and phosphoric acid. The inorganic acid may be used alone or in combination of two or more thereof.

Examples of the cationic resin (cationic polymer) include a cationic urethane-based resin, a cationic olefin resin, and a cationic amine-based resin. The cationic polymer is preferably water-soluble.

As the cationic urethane-based resin, a commercially available product may be used, and examples thereof include HYDRAN CP-7010, CP-7020, CP-7030, CP-7040, CP-7050, CP-7060, and CP-7610 (trade names, manufactured by DIC Corporation), SUPERFLEX 600, 610, 620, 630, 640, and 650 (trade names, manufactured by DKS Co., Ltd.), urethane emulsion WBR-2120C and WBR-2122C (trade names, manufactured by Taisei Fine Chemical Co., Ltd.).

The cationic olefin resin is a resin having an olefin such as ethylene and propylene in the structural skeleton, and a known resin may be appropriately selected and used. The cationic olefin resin may be in an emulsion state of being dispersed in a solvent containing water, an organic solvent, or the like. As the cationic olefin resin, a commercially available product may be used, and examples thereof include ARROWBASE CB-1200 and CD-1200 (trade names, manufactured by UNITIKA LTD.).

As the cationic amine-based resin (cationic polymer), any resin having an amino group in the structure may be used, and a known resin may be appropriately selected and used. Examples thereof include a polyamine resin, a polyamide resin, and a polyallylamine resin. The polyamine resin is a resin having an amino group in the main skeleton of the resin. The polyamide resin is a resin having an amide group in the main skeleton of the resin. The polyallylamine resin is a resin having a structure derived from an allyl group in the main skeleton of the resin.

Examples of a cationic polyamine-based resin include UNISENCE KHE103L (hexamethylene diamine/epichlorohydrin resin, pH of a 1% aqueous solution: approximately 5.0; viscosity: 20 to 50 (mPa·s); an aqueous solution of a solid content concentration of 50% by mass) and UNISENCE KHE104L (dimethylamine/epichlorohydrin resin, pH of a 1% aqueous solution: approximately 7.0; viscosity: 1 to 10 (mPa·s); an aqueous solution of a solid content concentration of 20% by mass) manufactured by SENKA Corporation. Furthermore, specific examples of commercially available products of the cationic polyamine-based resin include FL-14 (manufactured by SNF Co. Ltd.), ARAFIX 100, 251S, 255, and 255LOX (manufactured by ARAKAWA CHEMICAL INDUSTRIES, LTD.), DK-6810, 6853, and 6885; WS-4010, 4011, 4020, 4024, 4027, and 4030 (manufactured by SEIKO PMC CORPORATION), PAPYOGEN P-105 (manufactured by SENKA Corporation), Sumirez Resin 650 (30), 675A, 6615, and SLX-1 (manufactured by Taoka Chemical Co., Ltd.), Catiomaster (registered trademark) PD-1, 7, 30, A, PDT-2, PE-10, PE-30, DT-EH, EPA-SK01, and TMHMDA-E (manufactured by Yokkaichi Chemical Company, Limited), and Jetfix 36N, 38A, and 5052 (manufactured by Satoda Chemical Industrial Co., Ltd.).

Examples of the polyamine-based resin include a polyallylamine resin. Examples of the polyallylamine resin include polyallylamine hydrochloride, polyallylamineamide sulfate, allylamine hydrochloride-diallylamine hydrochloride copolymers, allylamine acetate-diallylamine acetate copolymers, allylamine hydrochloride-dimethylallylamine hydrochloride copolymers, allylamine-dimethylallylamine copolymers, polydiallylamine hydrochloride, polymethyldiallylamine hydrochloride, polymethyldiallylamineamide sulfate, polymethyldiallylamine acetate, polydiallyldimethylammonium chloride, diallylamine acetate-sulfur dioxide copolymers, diallylmethylethylammonium ethylsulfate-sulfur dioxide copolymers, methyldiallylamine hydrochloride-sulfur dioxide copolymers, diallyldimethylammonium chloride-sulfur dioxide copolymers, and diallyldimethylammonium chloride-acrylamide copolymers.

These aggregating agents may be used in combination. In addition, when at least one of a polyvalent metal salt, an organic acid, and a cationic resin is selected from these aggregating agents, the aggregation action is better, and thus it is possible to form an image having higher quality (particularly, better color developability). As the aggregating agent, a polyvalent metal salt is more preferably used, and a calcium salt is still more preferably used. This can further improve the image quality of the produced image.

The total aggregating agent content of the treatment liquid is, for example, 0.1% by mass or more and 25% by mass or less, preferably 1% by mass or more and 20% by mass or less, and more preferably 2% by mass or more and 15% by mass or less based on the total mass of the treatment liquid. Alternatively, the content is preferably 2% to 20% by mass, more preferably 5% to 20% by mass, and still more preferably 8% to 20% by mass.

Even when the aggregating agent is contained as a solution or a dispersion, the solid content is preferably within any of the above ranges. When the aggregating agent content is within or more than any of the above ranges, the aggregating agent exhibits sufficient ability to aggregate the components contained in the ink. When the aggregating agent content is within or less than any of the above ranges, the solubility and dispersibility of the aggregating agent in the treatment liquid are better, improving storage stability and the like of the treatment liquid.

### 1.2. Sugar Alcohol

The treatment liquid of the present embodiment contains a sugar alcohol that is solid as a simple substance at normal temperature. The term “normal temperature” as used herein refers to 25° C. The term “simple substance” refers to a state in which the sugar alcohol is present alone, not in a solution form such as an aqueous solution. The sugar alcohol refers to a sugar produced through reduction of a carbonyl group of an aldose or a ketose.

The sugar alcohol may be a chain sugar alcohol or a cyclic sugar alcohol. In addition, examples of the sugar alcohol include erythritol, inositol, mannitol, xylitol, sorbitol, lactitol, glycerin, and the like. Among these, the sugar alcohol contained in the treatment liquid of the present embodiment is a sugar alcohol that is solid as a simple substance at normal temperature. Therefore, for example, glycerin is a kind of sugar alcohol, but does not belong to sugar alcohols that are solid as a simple substance at normal temperature.

Further, as the sugar alcohol that is solid as a simple substance at normal temperature and that is contained in the treatment liquid of the present embodiment, those having the following properties are selected from such sugar alcohols. That is, the sugar alcohol that is solid as a simple substance at normal temperature and that is contained in the treatment liquid of the present embodiment is characterized by hygroscopicity or moisture retention of a 50 mass % aqueous solution thereof.

When a 50 mass % aqueous solution of the sugar alcohol that is solid as a simple substance at normal temperature and that is contained in the treatment liquid of the present embodiment is allowed to stand at 25° C. and 95% RH for 7 days, the mass change ratio before and after the standing (after standing/before standing) is 120% or less. The formula is: mass change ratio (%)=mass after standing/mass before standing×100. The mass change ratio is also referred to as a moisturizing factor.

The treatment liquid of the present embodiment may contain a plurality of sugar alcohols that are each solid as a simple substance at normal temperature. When the treatment liquid contains a plurality of sugar alcohols that are each solid as a simple substance at normal temperature, a 50 mass % aqueous solution of a mixture of all the sugar alcohols, which are each solid as a simple substance at normal temperature and that are contained in the treatment liquid, at a mass ratio at which they are contained in the treatment liquid satisfies the above mass change ratio.

As a container used to allow the 50 mass % aqueous solution of the sugar alcohol that is solid as a simple substance at normal temperature to stand, a container in which the surface area of the 50 mass % aqueous solution of the sugar alcohol that is solid as a simple substance at normal temperature is in a predetermined state is used. For example, NEOMINI CUP No. 5 (volume: 5 ml, inner mouth diameter: no flange, 25.2 mm) manufactured by Maruemu Corporation is used. The amount of the 50 mass % aqueous solution of the sugar alcohol to be contained in the container before the standing is 1 ml. Then, a value obtained by dividing the mass (mass of the aqueous solution) after the standing at 25° C. and 95% RH for 7 days by the mass (mass of the aqueous solution) before the standing is defined as the mass change ratio (%). Even when the sugar alcohol is a mixture of a plurality of sugar alcohols, the mass change ratio is measured as described above.

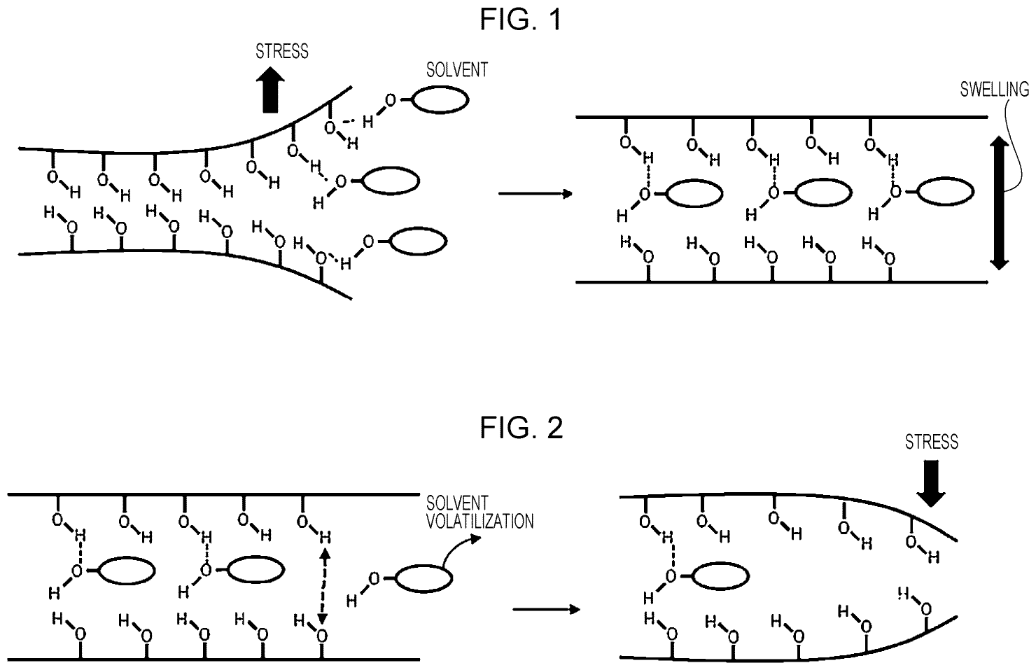

FIG. 1 is a conceptual diagram illustrating primary curling. FIG. 2 is a conceptual diagram illustrating secondary curling.

As shown on the left side of FIG. 1, in a case where the treatment liquid or the ink jet ink composition is attached to fibers of a recording medium, hydrogen bonds between cellulose molecules constituting the fibers are disrupted by water or solvent molecules. At the point where the hydrogen bonds are disrupted, the fibers swell, thereby generating stress that deforms the fibers. It is considered that the primary curling is caused by such a mechanism. Then, as shown on the right side of FIG. 1, it is considered that, when disruption of hydrogen bonds between the fibers is saturated, generation of the stress is stopped, the primary curling subsides, and the state is returned to the original state. It is considered that, since drying has not proceeded at this time, water and the solvent inhibit hydrogen bonding between cellulose molecules and remain, so that the fibers remain swollen.

On the other hand, thereafter, as shown in the left of FIG. 2, when drying of the treatment liquid or the ink jet ink composition progresses and water or the solvent is volatilized from the swollen fibers, it is considered that formation of hydrogen bonds between the fibers (cellulose) is started again. When volatilization of the solvent progresses and hydrogen bonds between the fibers are formed again as shown on the left side of FIG. 2, it is considered that the reformed hydrogen bonds are generated at random. It is considered that the hydrogen bonds reformed as described above are formed at positions different from the original state before the treatment liquid or the ink jet ink composition is attached. Accordingly, it is considered that a state in which stress is partially applied to the recording medium is formed, and secondary curling is caused.

In the treatment liquid of the present embodiment, since the contained sugar alcohol that is solid as a simple substance at normal temperature has a mass change ratio of 120% or less, when the treatment liquid is attached to an absorbent recording medium, moisture is easily evaporated and primary curling is easily suppressed compared to a case where the mass change ratio exceeds 120%. In addition, since the treatment liquid of the present embodiment contains the sugar alcohol that is solid as a simple substance at normal temperature, when the treatment liquid is attached to an absorbent recording medium and is dried, it is easy to inhibit reformation of hydrogen bonds of fibers, and it is easy to suppress secondary curling.

When a 50 mass % aqueous solution of the sugar alcohol that is solid as a simple substance at normal temperature and that is contained in the treatment liquid of the present embodiment is allowed to stand at 25° C. and 95% RH for 7 days, the mass change ratio before and after standing (after standing/before standing) is 120% or less. However, from the above viewpoint, the mass change ratio is more preferably 110% or less, still more preferably 100% or less, and yet still more preferably 90% or less. On the other hand, the mass change ratio is preferably 80% or more, more preferably 90% or more, still more preferably 100% or more, and yet still more preferably 110% or more. In addition, a mass change ratio within or less than any of the above ranges is preferable because more excellent curling suppression is exhibited. A mass change ratio within or more than any of the above ranges is preferable because ejection stability is more excellent.

The total content of the sugar alcohol that is solid as a simple substance at normal temperature in the treatment liquid is, for example, 0.5% by mass or more based on the total amount of the treatment liquid. The content is, for example, 0.5% by mass or more and 10% by mass or less, 0.5% by mass or more and 7% by mass or less, preferably 1% by mass or more and 5% by mass or less, and more preferably 2% by mass or more and 4% by mass or less.

### 1.3. Water

The treatment liquid according to the present embodiment is an aqueous treatment liquid containing water. The term “aqueous” means that the composition contains water as a primary solvent component. This allows recording to be performed with a reduced environmental load and less odor and the like.

Water may be included as a primary solvent of the treatment liquid and is a component evaporated and scattered when dried. Water is preferably pure water or ultrapure water from which ionic impurities have been removed as much as possible, such as ion-exchanged water, ultrafiltered water, reverse osmosis water, or distilled water. Further, when water sterilized by ultraviolet irradiation, addition of hydrogen peroxide, or the like is used, generation of mold or bacteria can be suppressed in a case where the treatment liquid is stored for a long period of time, which is preferable. The water content is preferably 45% by mass or more based on the total amount of the treatment liquid. The upper limit is, for example, 99% by mass or less. The water content is more preferably 50% by mass or more and 98% by mass or less, and still more preferably 55% by mass or more and 95% by mass or less.

### 1.4. Other Components

### 1. Surfactant

The treatment liquid according to the present embodiment may contain a surfactant. The surfactant is not particularly limited, and examples thereof include an acetylene glycol-based surfactant, a fluorine-based surfactant, and a silicone-based surfactant. The surfactant has a function of adjusting the surface tension of the treatment liquid and adjusting, for example, wettability with the recording medium.

The acetylene glycol-based surfactant is not particularly limited, and examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (which are all trade names, manufactured by Air Products Japan, K.K.), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (which are all trade names, manufactured by Nissin Chemical Industry Co., Ltd), and ACETYLENOL E00, E00P, E40, and E100 (which are all trade names, manufactured by Kawaken Fine Chemicals Co., Ltd).

As the fluorine-based surfactant, a fluorine-modified polymer is preferably used, and specific examples thereof include BYK-340 (product name, manufactured by BYK Japan KK).

The silicone-based surfactant is not particularly limited, and examples thereof preferably include a polysiloxane-based compound. The polysiloxane-based compound is not particularly limited, and examples thereof include polyether-modified organosiloxane. Examples of commercially available products of the polyether-modified organosiloxane include BYK-306, BYK-307, BYK-333, BYK-341, BYK-345, BYK-346, and BYK-348 (which are all trade names, manufactured by BYK Japan KK), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (which are all trade names, Shin-Etsu Chemical Co., Ltd.), and Silface SAG503A and Silface SAG014 (which are both trade names, manufactured by Nissin Chemical Industry Co., Ltd.).

The surfactant may be used alone or in combination of two or more thereof. When the surfactant is contained, the total content thereof is preferably 0.1% by mass or more and 1.5% by mass or less based on the total mass of the ink jet ink composition.

### 2. Resin Particles

The treatment liquid may contain resin particles. The resin particles may be able to further improve the adhesiveness of the image formed by the ink attached to the recording medium. Examples of the resin particle includes resin particles of urethane-based resins, acrylic resins (including styrene-acrylic resins), fluorene-based resins, polyolefin-based resins, rosin-modified resins, terpene-based resins, polyester resins, polyamide resins, epoxy resins, vinyl chloride resins, vinyl chloride-vinyl acetate copolymers, and ethylene vinyl acetate resins. Among these, a urethane-based resin, an acrylic resin, a polyolefin-based resin, and a polyester-based resin are preferable. These resin particles are usually handled in an emulsion form but may be handled in a powder form. The resin particles can be used alone or in combination of two or more thereof.

The glass transition temperature (Tg) of the resin particles is preferably −50° C. or higher and 200° C. or lower, more preferably 0° C. or higher and 150° C. or lower, and still more preferably 50° C. or higher and 100° C. or lower. In particular, the glass transition temperature is preferably 50° C. or higher and 80° C. or lower. When the glass transition temperature (Tg) of the resin particles is within any of the above ranges, the resin particles tend to be excellent in durability and clogging resistance. The glass transition temperature is measured, for example, using a differential scanning calorimeter “DSC7000,” manufactured by Hitachi High-Tech Science Corporation, in accordance with JIS K7121 (Testing Methods for Transition Temperatures of Plastics).

The volume-average particle diameter of the resin particles is preferably 10 nm or more and 300 nm or less, more preferably 30 nm or more and 300 nm or less, still more preferably 30 nm or more and 250 nm or less, and particularly preferably 40 nm or more and 220 nm or less. The volume-average particle diameter can be measured by the method described above.

The acid value of the resin of the resin particle is preferably 50 mg KOH/g or less, more preferably 30 mg KOH/g or less, even more preferably 20 mg KOH/g or less, and particularly preferably 10 mg KOH/g or less. The lower limit of the acid value is 0 mg KOH/g or more, preferably 5 mg KOH/g or more, and more preferably 10 mg KOH/g or more. Furthermore, the lower limit is preferably 15 mg KOH/g or more. This case is preferable because image quality and the like are excellent. Furthermore, when the acid value of the resin particles contained in the ink is within or more than any of the above ranges, a viscosity increase ratio of the ink composition of the ink described later can be readily set to be within or more than the range described later, which is preferable. The acid value can be measured by the method described above.

The resin particle content of the treatment liquid is preferably 20% by mass or less, more preferably 10% by mass or less, even more preferably 5% by mass or less, still more preferably 1% by mass or less, and particularly preferably 0.1% by mass or less on a solid basis based on the total mass of the treatment liquid, and the treatment liquid may contain no resin particles. However, when the resin particles are contained, the resin particle content is preferably 0.1% by mass or more, more preferably 1% by mass or more, and still more preferably 2% by mass or more.

The resin particle content of the ink is preferably 0.5% by mass or more, more preferably 1% by mass or more, and still more preferably 3% by mass or more on a solid basis based on the total mass of the ink. Furthermore, the resin particle content is preferably 20% by mass or less, more preferably 10% by mass or less, and still more preferably 8% by mass or less.

### 3. Organic Solvent

The treatment liquid according to the present embodiment may contain an organic solvent. The organic solvent is preferably water-soluble. One function of the organic solvent is to improve wettability of the treatment liquid with the recording medium or to increase the moisture retention of the treatment liquid. Furthermore, the organic solvent can also function as a moisturizing agent or a penetrant.

Examples of the organic solvent include esters, alkylene glycol ethers, cyclic esters, nitrogen-containing solvents, and polyhydric alcohols. Examples of the nitrogen-containing solvents include cyclic amides and acyclic amides. Examples of the acyclic amides include alkoxyalkylamides.

Examples of the esters include glycol monoacetates such as ethylene glycol monomethyl ether acetate, ethylene glycol monoethyl ether acetate, and ethylene glycol monobutyl ether acetate; and glycol diesters such as ethylene glycol diacetate, diethylene glycol diacetate, and propylene glycol diacetate.

The alkylene glycol ethers may be alkylene glycol monoethers or diethers, and are preferably alkyl ethers. Specific examples thereof include alkylene glycol monoalkyl ethers such as ethylene glycol monomethyl ether, ethylene glycol monoethyl ether, ethylene glycol monoisopropyl ether, and ethylene glycol monobutyl ether, and diethylene glycol monomethyl ether; and alkylene glycol dialkyl ethers such as ethylene glycol dimethyl ether, ethylene glycol diethyl ether, ethylene glycol dibutyl ether, diethylene glycol dimethyl ether, and diethylene glycol diethyl ether.

Examples of the cyclic esters include cyclic esters (lactones) such as β-propiolactone, γ-butyrolactone, δ-valerolactone, ε-caprolactone, and β-butyrolactone; and a compound in which a hydrogen atom of a methylene group adjacent to the carbonyl group of any of the cyclic esters is substituted with an alkyl group having 1 to 4 carbon atoms.

Examples of the alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, and 3-n-butoxy-N,N-methylethylpropionamide.

Examples of the cyclic amides include lactams and include pyrrolidones such as 2-pyrrolidone, 1-methyl-2-pyrrolidone, 1-ethyl-2-pyrrolidone, 1-propyl-2-pyrrolidone, and 1-butyl-2-pyrrolidone. These are preferable from the viewpoint of solubility of the aggregating agent and promotion of film formation of the resin particles described later, and 2-pyrrolidone is particularly preferable.

In addition, it is also preferable to use a compound represented by General Formula (1) as the alkoxyalkylamides.

R¹—O—CH₂CH₂—(C═O)—NR²R³ (1)

In Formula (1), R¹ represents an alkyl group having 1 or more and 4 or less carbon atoms, and R² and R³ each independently represent a methyl group or an ethyl group. The “alkyl group having 1 or more and 4 or less carbon atoms” may be a linear or branched alkyl group, and examples thereof include a methyl group, an ethyl group, an n-propyl group, an iso-propyl group, an n-butyl group, a sec-butyl group, an iso-butyl group, and a tert-butyl group. The compounds represented by Formula (1) may be used alone or in combination of two or more thereof.

The function of the nitrogen-containing solvent is, for example, to enhance the surface drying properties and the fixing properties of the treatment liquid attached onto a low-absorbent recording medium. In particular, the compound represented by Formula (1) is excellent in the action of moderately softening and dissolving a vinyl chloride-based resin. Thus, the compound represented by Formula (1) can soften and dissolve a recording surface containing the vinyl chloride-based resin to allow the treatment liquid to permeate into the low-absorbent recording medium. When the treatment liquid permeates into the low-absorbent recording medium in this manner, the treatment liquid is firmly fixed, and the surface of the treatment liquid is easily dried. Accordingly, a produced image is likely to have excellent surface drying properties and fixing properties.

When the treatment liquid contains the nitrogen-containing solvent, the nitrogen-containing solvent content is preferably not more than 15% by mass, more preferably not more than 10% by mass, and still more preferably not more than 5% by mass based on the total mass of the treatment liquid. Furthermore, the content is preferably not more than 2% by mass, and more preferably not more than 1% by mass.

In particular, it is preferable that the treatment liquid contain no amide solvent. Graininess and abrasion resistance of a produced image can be further improved accordingly.

Examples of the polyhydric alcohols include 1,2-alkanediols (for example, alkanediols such as ethylene glycol, propylene glycol (also known as propane-1,2-diol), 1,2-butanediol, 1,2-pentanediol, 1,2-hexanediol, 1,2-heptanediol, and 1,2-octanediol), and polyhydric alcohols (polyols) excluding the 1,2-alkanediols (for example, diethylene glycol, dipropylene glycol, 1,3-propanediol, 1,3-butanediol (also known as 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, and glycerin).

Examples of the polyhydric alcohols include alkanediols and polyols. Among the alkanediols, an alkanediol having 5 or more carbon atoms is preferable. The number of carbon atoms of the alkane is preferably 5 to 10, more preferably 5 to 8, and even more preferably 5 or 6. 1,2-Alkanediols are preferable. Preferred examples thereof include 1,2-hexanediol and 1,2-pentanediol.

When the 1,2-alkanediol having 5 or more carbon atoms is contained, spreadability of the treatment liquid on the recording medium is further improved, the aggregating agent can be more uniformly attached, and the color developability of the ink jet ink composition can be further improved. In addition, the ejection stability of the treatment liquid can also be made more excellent.

The alkanediols may be an alkanediol having 4 or less carbon atoms.

Examples of the polyols include a condensate obtained by condensation of hydroxyl groups between molecules of an alkanediol, and a polyol having three or more hydroxyl groups. As the condensate obtained by condensation of hydroxyl groups of an alkanediol between molecules, a condensate in which hydroxyl groups of an alkanediol having 4 or less carbon atoms are condensed between molecules is preferable.

Among the polyhydric alcohols, an alkanediol having 4 or less carbon atoms, a condensate obtained by condensation of hydroxyl groups of an alkanediol between molecules, and a polyol having three or more hydroxyl groups are excellent in moisture retention among the organic solvents, can be used as a moisturizing agent (moisturizing solvent), and are more excellent in ejection stability, and thus are preferable.

The alkanediols and polyols can mainly function as a penetrating solvent and/or a moisturizing solvent. However, the alkanediols tend to have strong properties as the penetrating solvent, and polyols tend to have strong properties as the moisturizing solvent.

The treatment liquid may contain an organic solvent that is a polyhydric alcohol having a normal boiling point of 170° C. or more and 240° C. or less, and this case is preferable because the graininess and abrasion resistance of the image can be further improved. The treatment liquid more preferably contains an organic solvent that is a polyol having a normal boiling point of 170° C. or more and 240° C. or less. This case is more preferable from the above-described point.

When the treatment liquid contains the organic solvent, the organic solvent may be used alone or in combination of two or more thereof. The total content of the organic solvent based on the total mass of the treatment liquid is, for example, 1% by mass or more and 50% by mass or less.

Furthermore, the content is preferably 5% by mass or more and 50% by mass or less, preferably 10% by mass or more and 45% by mass or less, more preferably 15% by mass or more and 40% by mass or less, and still more preferably 20% by mass or more and 40% by mass or less. The content is further preferably 25% to 35% by mass. When the organic solvent content is within any of the above ranges, the balance between wet spreadability and dryness is further improved, and an image having high image quality is easily formed.

The content of the organic solvent that is a polyol having a normal boiling point of 170° C. or more and 240° C. or less may be within any of the above ranges, and this case is preferable. The content of the organic solvent that is a polyhydric alcohol having a normal boiling point of 170° C. or more and 240° C. or less may be within any of the above ranges, and this case is preferable.

It is preferable that the treatment liquid do not contain 1 mass % or more of a polyhydric alcohol having a normal boiling point exceeding 280° C., and it is more preferable that the treatment liquid do not contain 0.5 mass % or more of a polyhydric alcohol having a normal boiling point exceeding 280° C. Furthermore, the content of an organic solvent not limited to the polyhydric alcohol and having a normal boiling point exceeding 280° C. may be within any of the above ranges, and this case is preferable.

### 4. Wax

The treatment liquid may contain a wax. Since the wax has a function to impart smoothness to an image formed by the ink, peeling of the image or the like can be reduced in some cases.

Examples of a component constituting the wax include plant- or animal-derived waxes such as carnauba wax, candelilla wax, beeswax, rice wax, and lanolin; petroleum waxes, such as paraffin wax, microcrystalline wax, polyethylene wax, oxidized polyethylene wax, and petrolatum; mineral waxes, such as montan wax and ozokerite; synthetic waxes such as carbon wax, Hoechst wax, polyolefin wax, and stearic acid amide; and α-olefin-maleic anhydride copolymers, and a natural/synthetic wax emulsion, a wax blend, or the like thereof may be used alone or as a mixture of multiple kinds. Among these, polyolefin wax (particularly, polyethylene wax and polypropylene wax) and paraffin wax are preferably used from the viewpoint that the effect of enhancing fixing properties to a soft packaging film described later is more excellent.

As the wax, a commercially available product may be used as it is, and examples thereof include NOPCOTE PEM-17 (trade name, manufactured by SAN NOPCO LIMITED), CHEMIPEARL W4005 (trade name, manufactured by Mitsui Chemicals, Inc.), and AQUACER 515, 539, and 593 (which are all trade names, manufactured by BYK Japan KK).

The melting point of the wax is preferably 50° C. or more and 200° C. or less, and a wax having a melting point of 70° C. or more and 180° C. or less is more preferably used, and a wax having a melting point of 90° C. or more and 150° C. or less is still more preferably used.

The wax may be supplied in the form of an emulsion or suspension. The wax content is 0.1% by mass or more and 10% by mass or less, more preferably 0.5% by mass or more and 5% by mass or less, and still more preferably 0.5% by mass or more and 2% by mass or less in terms of solid content based on the total mass of the treatment liquid. When the wax content is within the above ranges, the function of the wax can be exhibited well. Note that, when the treatment liquid and at least one of a clear ink composition and an ink composition described later contain the wax, it is possible to more sufficiently obtain the function to impart smoothness to an image.

### 5. Betaine

The treatment liquid of the present embodiment may include a betaine. The term “betaine” refers to a compound having a positive charge and a negative charge at non-adjacent positions in the same molecule, in which a hydrogen atom capable of dissociating is not bonded to the atom having the positive charge, possibly constituting an intramolecular salt, and the compound is not charged as a whole molecule. In the present embodiment, the betaine preferably has a quaternary ammonium cation as the positively charged moiety.

When the treatment liquid contains the betaine, it is possible to suppress misdirection and discharge failure of the treatment liquid caused when the treatment liquid dries in a nozzle of an ink jet head, and it is possible to make clogging resistance excellent. Further, when the treatment liquid contains the betaine, secondary curling can be further suppressed.

The betaine is not particularly limited, and examples thereof include trimethylglycine, trialkylglycines such as triethylglycine, γ-butyrobetaine, homarine, trigonelline, carnitine, homoserine betaine, valine betaine, lysine betaine, ornithine betaine, alanine betaine, stachydrin, and glutamic acid betaine. Among these, the glycine contained in the ink jet ink composition is preferably selected from trialkylglycines, and trimethylglycine is more preferably contained. The trialkylglycines are a compound in which three alkyl groups are substituted on the nitrogen atom of glycine. Consequently, clogging resistance tends to be further improved. The betaine may be used alone or in combination of two or more thereof.

The number of carbon atoms constituting the betaine is preferably 4 or more and 12 or less, more preferably 4 or more and 7 or less, and still more preferably 4 or more and 6 or less. When the number of carbon atoms of the betaine is within any of the above ranges, suppression of precipitation of a pigment tends to be more remarkable.

In a case where the betaine is contained in the treatment liquid, the content thereof is preferably 1.0% by mass or more based on the total mass of the treatment liquid. Furthermore, the content is preferably 2.0% by mass or more and 10.0% by mass or less, more preferably 3.0% by mass or more and 9.0% by mass or less, and still more preferably 4.0% by mass or more and 8.0% by mass or less.

### 6. Additive

The treatment liquid may contain a urea, an amine, a saccharide, or the like as an additive. Examples of the urea include urea, ethyleneurea, tetramethylurea, thiourea, and 1,3-dimethyl-2-imidazolidinone.

Examples of the amine include diethanolamine, triethanolamine, and triisopropanolamine. The urea and amine may function as a pH adjuster.

Examples of the saccharide include glucose, mannose, fructose, ribose, xylose, arabinose, galactose, aldonic acid, glucitol (sorbitol), maltose, cellobiose, lactose, sucrose, trehalose, and maltotriose.

### 7. Others

The treatment liquid according to the present embodiment may further contain a component such as a preservative/fungicide, a rust inhibitor, a chelating agent, a viscosity modifier, an antioxidant, or a fungicide, if necessary.

### 1.5. Recording Medium

The treatment liquid of the present embodiment is used for recording on an absorbent recording medium. The absorbent recording medium refers to a “recording medium in which the water absorption amount from the start of contact to 30 msec^{1/2} in the Bristow's method is greater than that of 10 mL/m².” The Bristow's method is the most popular method for measuring a liquid absorption amount in a short time and is also adopted by Japan Technical Association of the Pulp and Paper Industry (JAPAN TAPPI). Details of the test method are described in the standard No. 51 “Method for determining the liquid absorbability of paper and board (Bristow's method)” in “JAPAN TAPPI Paper Pulp Test Method 2000 Edition.”

Examples of the liquid absorbent recording medium include a recording medium in which a base material itself of the recording medium is liquid absorbent. Examples of such a recording medium include fabric made of fibers and paper containing pulp as a component. Examples of the paper include plain paper, thick paper, and liner paper. Examples of liner paper include paper formed of paper such as kraft pulp, used paper, or the like. Examples of the plain paper include those generally called high-quality paper, neutral paper, and copy paper.

Examples of the liquid absorbent recording medium include a recording medium in which a receiving layer that absorbs a liquid is provided on a surface of the recording medium to exhibit liquid absorbability. Examples thereof include ink jet paper (paper dedicated to ink jet printing). Examples of the receiving layer that absorbs a liquid include a layer composed of a liquid absorbent resin, liquid absorbent inorganic fine particles, or the like.

The treatment liquid according to the present embodiment can be used and embodied without being restricted by the recording medium, but a more remarkable effect is obtained by using an absorbent recording medium as the recording medium. Further, this effect is more remarkable in the case of a recording medium in which the base material itself of the recording medium is liquid absorbent.

### 1.6. Physical Properties and Production of Treatment Liquid

The treatment liquid of the present embodiment has a surface tension at 25° C. of 40 mN/m or less, preferably 38 mN/m or less, more preferably 35 mN/m or less, and even more preferably 30 mN/m or less, from the viewpoint of achieving appropriate wet spreadability on the recording medium. The surface tension can be determined by confirming a surface tension measured by using an automatic surface tensiometer CBVP-Z (manufactured by Kyowa Interface Science Co., Ltd) when a platinum plate is wetted with the composition under an environment of 25° C.

The treatment liquid is more preferably attached to the recording medium by an ink jet method. In such a case, the viscosity at 20° C. is preferably 1.5 mPa·s or more and 15 mPa·s or less, more preferably 1.5 mPa·s or more and 7 mPa·s or less, and still more preferably 1.5 mPa·s or more and 5.5 mPa·s or less. When the treatment liquid is attached to the recording medium using the ink jet method, it is easy to efficiently form a predetermined treatment liquid attachment area on the recording medium.

The treatment liquid of the present embodiment can be obtained by mixing the above-described components in an arbitrary order and removing impurities by filtration or the like as necessary. As a mixing method, a method of sequentially adding materials to a container provided with a stirring device such as a mechanical stirrer or a magnetic stirrer and stirring and mixing the materials is suitably used. As a filtration method, for example, centrifugal filtration, filter filtration, or the like can be performed as necessary.

### 2. Ink Set

The treatment liquid described above is used for recording together with an ink jet ink composition containing a coloring material. An ink set according to the present embodiment includes the treatment liquid described above and an ink jet ink composition. The ink jet ink composition containing a coloring material will be described below.

### 2.1. Ink Jet Ink Composition

The ink jet ink composition is an aqueous ink composition containing a coloring material.

### 2.1.1. Coloring Material

The ink jet ink composition is an ink containing a coloring material. Examples of the coloring material include a dye and a pigment. The coloring material may be a color coloring material such as a cyan, yellow, magenta, or black coloring material, or a white coloring material. In addition, special color inks such as red, orange, blue, and green, and light color inks such as light magenta, light cyan, and gray may be used.

The coloring material may be either a dye or a pigment, or may be a mixture thereof. However, among a dye and a pigment, it is more preferable to include a pigment. The pigment is excellent in storage stability such as light resistance, weather resistance, and gas resistance, and is preferably an organic pigment from that viewpoint.

Specific examples of the pigment include azo pigments such as an insoluble azo pigment, a condensed azo pigment, an azo lake, and a chelated azo pigment, polycyclic pigments such as a phthalocyanine pigment, perylene and perinone pigments, an anthraquinone pigment, a quinacridone pigment, a dioxane pigment, a thioindigo pigment, an isoindolinone pigment, and a quinophthalone pigment, a dye chelate, a dye lake, a nitro pigment, a nitroso pigment, aniline black, a daylight fluorescent pigment, and carbon black. These pigments may be used alone or in combination of two or more thereof. Furthermore, a brilliant pigment may be used as the coloring material.

Specific examples of the pigment are not particularly limited, but include the following, for example.

Examples of a black pigment include No. 2300, No. 900, MCF 88, No. 33, No. 40, No. 45, No. 52, MA7, MA8, MA100, and No. 2200B (which are all manufactured by Mitsubishi Chemical Corporation), Raven 5750, Raven 5250, Raven 5000, Raven 3500, Raven 1255, and Raven 700 (which are all manufactured by Columbia Carbon Corporation), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (which are all manufactured by CABOT JAPAN K.K.), Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (which are all manufactured by Degussa AG).

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of a cyan pigment include C.I. Pigment Blue 1, 2, 3, 15, 15:1, 15:2, 15:3, 15:34, 15:4, 16, 18, 22, 25, 60, 65, and 66, and C.I. Vat blue 4 and 60.

In addition, pigments other than the magenta, cyan, and yellow pigments are not particularly limited, and examples thereof include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

A pearl pigment is not particularly limited, and examples thereof include pigments having pearlescent or interference luster, such as titanium dioxide-coated mica, fish scale foil, and bismuth oxychloride.

A metallic pigment is not particularly limited, and examples thereof include particles formed of elemental metals, such as aluminum, silver, gold, platinum, nickel, chromium, tin, zinc, indium, titanium, and copper, and alloys thereof.

Examples of the white coloring material include metal compounds such as a metal oxide, barium sulfate, and calcium carbonate. Examples of the metal oxide include titanium dioxide, zinc oxide, silica, alumina, and magnesium oxide. In addition, particles having a hollow structure may be used as the white coloring material, and as the particles having a hollow structure, known particles may be used. As the white coloring material, among the exemplified materials, titanium dioxide is preferably used from the viewpoint of good whiteness and abrasion resistance.

In addition, as the dye, for example, various dyes normally used for ink jet recording, such as direct dyes, acidic dyes, edible dyes, basic dyes, reactive dyes, dispersion dyes, vat dyes, soluble vat dyes, and reaction dispersion dyes may be used.

The coloring material is preferably able to be stably dispersed or dissolved in a dispersion medium, and the coloring material may be dispersed using a dispersant as necessary.

The coloring material is preferably able to be stably dispersed in the dispersion medium, and therefore, the coloring material may be dispersed using a dispersant. Examples of the dispersant include a resin dispersant, and the dispersant is selected from dispersants which can improve dispersion stability of the coloring material in the ink jet ink composition. In addition, the coloring material may be used as a self-dispersible pigment by oxidizing or sulfonating the surface of the pigment with, for example, ozone, hypochlorous acid, or fuming sulfuric acid to modify surfaces of pigment particles.

Examples of the resin dispersant (dispersant resin) include (meth)acrylic resins such as poly(meth)acrylic acid, (meth)acrylic acid-acrylonitrile copolymers, (meth)acrylic acid-(meth)acrylic acid ester copolymers, vinyl acetate-(meth)acrylic acid ester copolymers, vinyl acetate-(meth)acrylic acid copolymers, and vinyl naphthalene-(meth)acrylic acid copolymers, and salts thereof; styrene-based resins such as styrene-(meth)acrylic acid copolymers, styrene-(meth)acrylic acid-(meth)acrylic acid ester copolymers, styrene-α-methylstyrene-(meth)acrylic acid copolymers, styrene-α-methylstyrene-(meth)acrylic acid-(meth)acrylic acid ester copolymers, styrene-maleic acid copolymers, and styrene-maleic acid anhydride copolymers, and salts thereof; urethane-based resins, which are polymer compounds (resins) having a urethane bond formed when an isocyanate group reacts with a hydroxy group, and which may be linear and/or branched regardless of whether being crosslinked or not, and salts thereof; polyvinyl alcohols; vinyl naphthalene-maleic acid copolymers and salts thereof; vinyl acetate-maleic acid ester copolymers and salts thereof; and water-soluble resins such as vinyl acetate-crotonic acid copolymers and salts thereof. Among these, a copolymer of a monomer having a hydrophobic functional group and a monomer having a hydrophilic functional group, and a polymer including a monomer having both a hydrophobic functional group and a hydrophilic functional group are preferable. As the form of the copolymer, any form of a random copolymer, a block copolymer, an alternating copolymer, and a graft copolymer may be used. Among the styrene resins, a copolymer with a (meth)acrylic monomer is also a (meth)acrylic resin.

Examples of commercially available products of a styrene-based resin dispersant include X-200, X-1, X-205, X-220, and X-228 (manufactured by SEIKO PMC CORPORATION), NOPCOSPERSE (registered trademark) 6100 and 6110 (manufactured by SAN NOPCO LIMITED), JONCRYL 67, 586, 611, 678, 680, 682, and 819 (manufactured by BASF SE), DISPER BYK-190 (manufactured by BYK Japan KK), and N-EA137, N-EA157, N-EA167, N-EA177, N-EA197D, N-EA207D, and E-EN10 (manufactured by DKS Co., Ltd.).

In addition, examples of commercially available products of an acrylic resin dispersant include BYK-187, BYK-190, BYK-191, BYK-194N, and BYK-199 (manufactured by BYK Japan KK), and Aron A-210, A6114, AS-1100, AS-1800, A-30SL, A-7250, and CL-2 (manufactured by TOAGOSEI CO., LTD.).

Furthermore, examples of commercially available products of a urethane resin dispersant include BYK-182, BYK-183, BYK-184, and BYK-185 (manufactured by BYK Japan KK), TEGO Dispers 710 (manufactured by Evonik Tego Chemie GmbH), and Borchi (registered trademark) Gen 1350 (manufactured by OMG Borchers GmbH).

The dispersant may be used alone or in combination of two or more thereof. The total dispersant content is preferably 0.1 parts by mass or more and 30 parts by mass or less, more preferably 0.5 parts by mass or more and 25 parts by mass or less, further more preferably 1 part by mass or more and 20 parts by mass or less, and still further more preferably 1.5 parts by mass or more and 15 parts by mass or less based on 50 parts by mass of the coloring material. When the dispersant content is 0.1 parts by mass or more based on 50 parts by mass of the coloring material, dispersion stability of the coloring material can be further improved. In addition, when the dispersant content is 30 parts by mass or less based on 50 parts by mass of the coloring material, the viscosity of the obtained dispersion can be suppressed to be small.

Among the dispersants exemplified above, at least one selected from anionic dispersant resins is more preferable. In this case, it is more preferable that a weight average molecular weight of the dispersant be 500 or more. Furthermore, the weight average molecular weight is preferably 5,000 or more and 100,000 or less, and more preferably 10,000 or more and 50,000 or less.

By using such a resin dispersant as the dispersant, dispersibility and aggregability of the pigment are further improved, and an image having better dispersion stability and higher image quality can be produced. In addition, the viscosity increase ratio of the ink jet ink composition described later is easily made a factor of 5 or more, which is preferable.

The anionic dispersant resin is a resin having an anionic functional group and exhibiting anionic properties. Examples of the anionic functional group include a carboxy group, a sulfo group, and a phosphoric acid group. Among these groups, a carboxy group is more preferable.

The dispersant resin preferably has an acid value, and the acid value is preferably 5 mg KOH/g or more, more preferably 10 to 200 mg KOH/g, and even more preferably 15 to 150 mg KOH/g. Furthermore, the acid value is preferably 20 to 100 mg KOH/g, and more preferably 30 to 80 mg KOH/g. Furthermore, the lower limit is preferably 40 mg KOH/g or more, more preferably 50 mg KOH/g or more, particularly preferably 60 mg KOH/g or more, and particularly more preferably 70 mg KOH/g or more. In this case, the viscosity increase ratio of the ink jet ink composition described later is easily made a factor of 5 or more, which is preferable.

The acid value can be measured by a neutralization titration method in accordance with JIS K0070. As a titration device, for example, “AT610” manufactured by Kyoto Electronics Manufacturing Co., Ltd. can be used.

The content of the coloring material is preferably 0.3% by mass or more and 20% by mass or less and more preferably 0.5% by mass or more and 15% by mass or less based on the total mass of the ink jet ink composition. Further, the content is preferably 1% by mass or more and 10% by mass or less, and more preferably 2% by mass or more and 7% by mass or less.

When the pigment is used as the coloring material, the volume-average particle diameter of the pigment particles is preferably 10 nm or more and 300 nm or less, more preferably 30 nm or more and 250 nm or less, still more preferably 50 nm or more and 250 nm or less, and particularly preferably 70 nm or more and 200 nm or less. Furthermore, the volume-average particle diameter is preferably 80 nm or more and 150 nm or less. The volume-average particle diameter of the coloring material is measured as an initial state by the above-described method for determining the volume-average particle diameter. The volume-average particle diameter in any of the above ranges is preferable because a desired coloring material is easily obtained and the characteristics of the coloring material are easily improved.

### 2.1.2. Water

The ink jet ink composition according to the present embodiment is an aqueous ink containing water. The term “aqueous” means that the composition contains water as a primary solvent component. This allows recording to be performed with a reduced environmental load and less odor and the like. Water and the water content may be similar to water and the water content of the above-described treatment liquid, and the description thereof is omitted.

### 2.1.3. Other Components

The ink jet ink composition may contain, in addition to the coloring material and water, components such as resin particles, an organic solvent, a surfactant, wax, an additive, an antiseptic/antifungal agent, an antirust agent, a chelating agent, a viscosity modifier, an antioxidant, and a fungicide.

The components other than the coloring material of the ink jet ink composition may be similar to those which may be used as the components of the treatment liquid other than the aggregating agent, or may be selected independently from the treatment liquid. These components may be similar to those of the treatment liquid described above, and a detailed description thereof is omitted by replacing the “treatment liquid” with the “ink jet ink composition.”

### 2.2. Physical Properties and Production of Ink Jet Ink Composition

The ink jet ink composition used in the recording method of the present embodiment has a surface tension at 25° C. of 40 mN/m or less, preferably 38 mN/m or less, more preferably 35 mN/m or less, and even more preferably 30 mN/m or less, from the viewpoint of achieving appropriate wet spreadability on the recording medium. The surface tension can be determined by confirming a surface tension measured by using an automatic surface tensiometer CBVP-Z (manufactured by Kyowa Interface Science Co., Ltd.) when a platinum plate is wetted with the composition under an environment of 25° C.

The ink jet ink composition is attached to the recording medium by an ink jet method. Therefore, the viscosity at 20° C. is preferably 1.5 mPa·s or more and 15 mPa·s or less, more preferably 1.5 mPa·s or more and 7 mPa·s or less, and still more preferably 1.5 mPa·s or more and 5.5 mPa·s or less.

The ink jet ink composition according to the present embodiment can be obtained by mixing the above-described components in an arbitrary order and removing impurities by filtration or the like as necessary. As a mixing method, a method of sequentially adding materials to a container provided with a stirring device such as a mechanical stirrer or a magnetic stirrer and stirring and mixing the materials is suitably used. As a filtration method, for example, centrifugal filtration, filter filtration, or the like can be performed as necessary.

Since the ink set of the present embodiment includes the treatment liquid described above, even when the ink set is used for recording together with the ink jet ink composition, a recorded material in which curling of the recording medium is suppressed can be formed.

### 3. Recording Method

A recording method according to the present embodiment is performed using the treatment liquid described above and the ink jet ink composition described above, and includes a treatment liquid attaching step of attaching the treatment liquid to a recording medium that is an absorbent recording medium, and an ink attaching step of ejecting the ink jet ink composition from an ink jet head to attach the ink jet ink composition to the recording medium.

### 3.1. Treatment Liquid Attaching Step

The treatment liquid attaching step may be performed by various methods such as a roller method, a spray method, a dip method, and an ink jet method. In particular, the ink jet method may be used, that is, the treatment liquid may be ejected from an ink jet head and attached to the recording medium, and the ink jet method is preferable because the amount and position of the treatment liquid attached thereto are easily controlled.

In this case, for example, an aspect in which the treatment liquid is attached while performing scanning which is movement of a relative position between the ink jet head and the recording medium using a recording apparatus described later is exemplified, and the treatment liquid may be attached by any method. Examples of the ink jet type include a serial type and a line type. This enables a small apparatus to efficiently perform small-volume and multi-type printing.

The amount of the treatment liquid attached in the treatment liquid attaching step is preferably 0.4 mg/inch² or more. Furthermore, the amount is preferably 0.5 mg/inch² or more, more preferably 1.0 mg/inch² or more, further preferably 1.5 mg/inch² or more, and even more preferably 2.0 mg/inch² or more. This enables production of an image having better filling properties. In addition, the maximum amount of the treatment liquid attached in the treatment liquid attaching step may be within or more than any of the above ranges, which is preferable.

The upper limit of the amount of the treatment liquid attached in the treatment liquid attaching step is preferably 5.0 mg/inch² or less. The amount is more preferably 3.0 mg/inch² or less, still more preferably 2.5 mg/inch² or less, and further more preferably 2.0 mg/inch² or less. In particular, the maximum amount of the treatment liquid attached in the treatment liquid attaching step may be within or less than any of the above ranges, which is preferable.

In addition, when the treatment liquid attaching step is performed by the ink jet method, the mass (ng) of a liquid droplet of the treatment liquid is preferably 0.5 ng or more and 10 ng or less, more preferably 1 ng or more and 7 ng or less, even more preferably 1 ng or more and 5 ng or less, and still even more preferably 2 ng or more and 4 ng or less. The mass (ng) of the droplet of the treatment liquid in the treatment liquid attaching step is, in terms of dot size (ng/dot), preferably 0.5 ng/dot or more and 10 ng/dot or less, more preferably 1 ng/dot or more and 7 ng/dot or less, further preferably 1 ng/dot or more and 5 ng/dot or less, and still further preferably 2 ng/dot or more and 4 ng/dot or less.

After the treatment liquid is attached to the recording medium in the treatment liquid attaching step, the ink attaching step may be performed to attach the ink to the recording medium. Alternatively, the treatment liquid attaching step may attach the treatment liquid to the same scanning region in the same scanning as the scanning (pass) in which the ink composition is attached to the recording medium.

The treatment liquid attaching step is performed so that the ink composition attached to the recording medium in the ink attaching step and the treatment liquid attached to the recording medium in the treatment liquid attaching step can come into contact with each other and react on the recording medium.

In the treatment liquid attaching step, the treatment liquid may be ejected from a line type ink jet head as the ink jet head and attached to the recording medium through scanning once. When such a recording apparatus is used, the ink jet ink composition is attached at an early stage after the treatment liquid is attached, which results in a situation in which curling easily occurs. However, a recorded material in which curling is suppressed can be obtained, and thus, for example, recorded materials can be stacked well after recording.

### 3.2. Ink Attaching Step

In the ink attaching step, the ink composition is ejected from the ink jet head and attached to the recording medium. The step of attaching the ink jet ink composition to the recording medium can be performed using, for example, a recording apparatus described later. That is, an ink jet head is filled with the ink jet ink composition so that the ink jet ink composition can be ejected from a predetermined nozzle, and in this state, the ink jet ink composition is ejected to the recording medium at a predetermined timing, thereby attaching the ink jet ink composition to the recording medium.

### 3.3. Other Steps

In addition, the recording method of the present embodiment may appropriately include a step of heating the recording medium. For example, when an ink jet recording apparatus is used, the step of heating the recording medium can be performed using an appropriate drying unit or the like. In addition, the drying can be performed by an appropriate drying unit regardless of whether or not the drying unit is provided in the ink jet recording apparatus. As a result, the obtained image can be dried, bleeding of the image can be suppressed, and the image can be fixed more efficiently. The method may further include a step of replenishing an ink storage container with ink. Furthermore, in the recording method of the present embodiment, other steps may be appropriately added, and for example, a step of applying another composition may be included.

### 3.4. Recording Apparatus

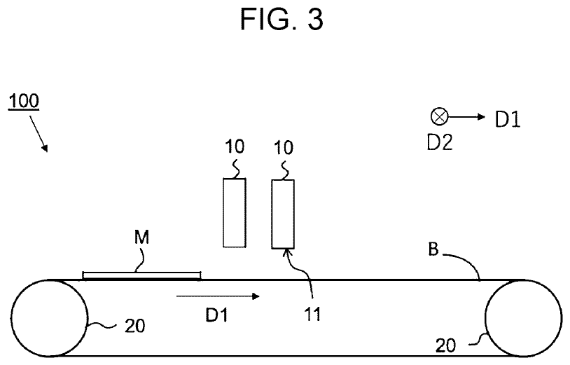

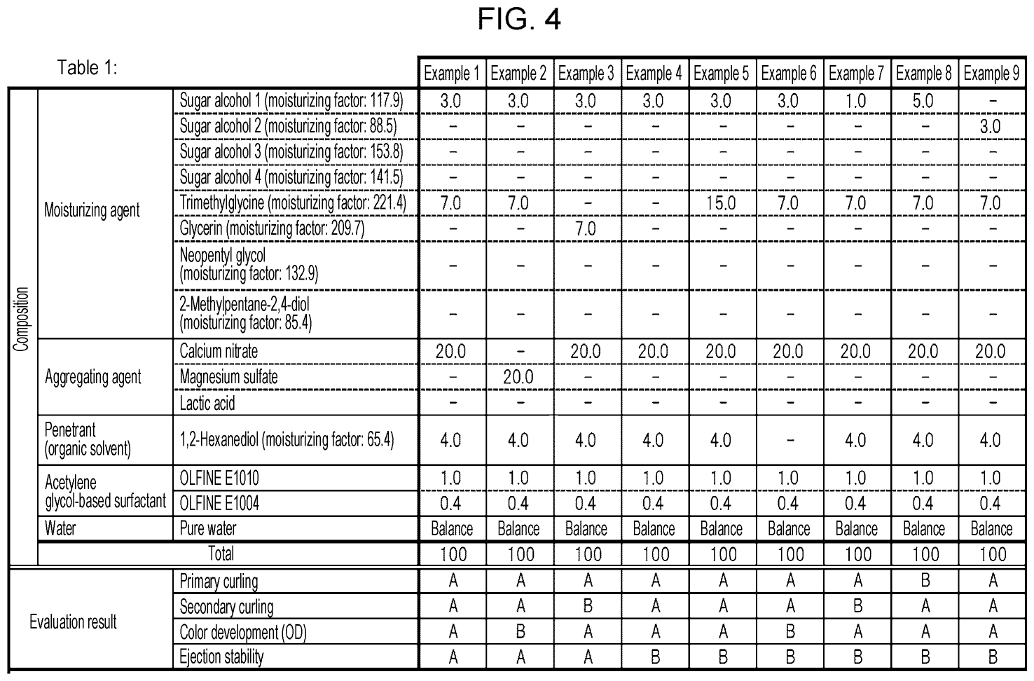

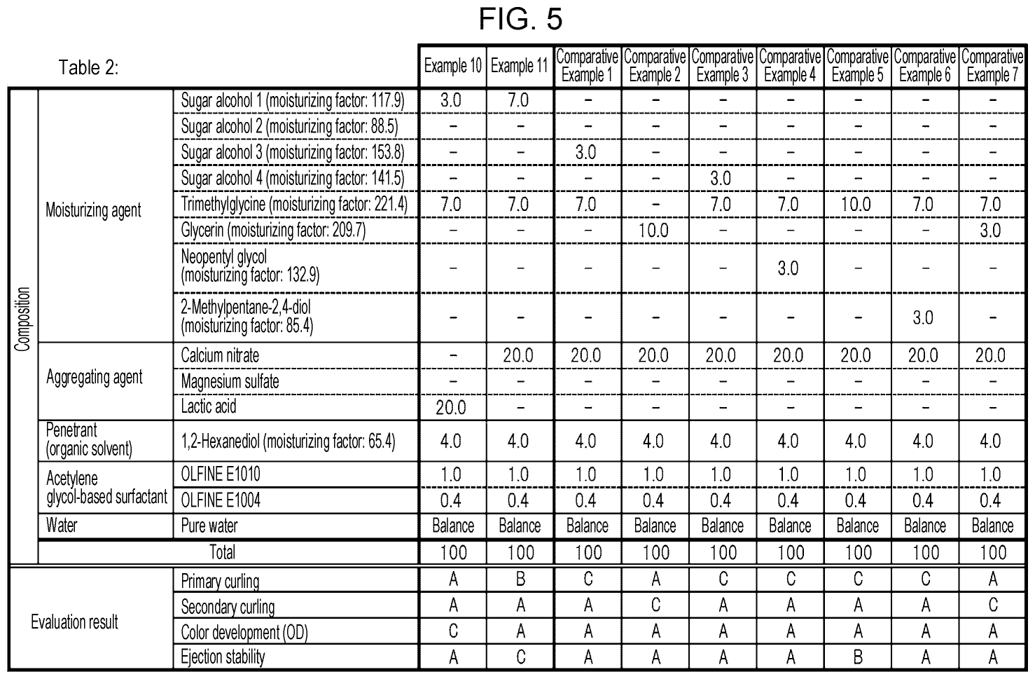

FIG. 3 illustrates a schematic cross-sectional view of a recording apparatus capable of being used in the recording method of the present disclosure. As shown in FIG. 3, each line head 10 has a length equal to or greater than the recording width of the recording medium, and is a unit that ejects the ink jet ink composition and causes the ink jet ink composition to be attached to a recording medium M. The ink jet head 10 has a plurality of unit heads 12 arranged in the direction of the recording width of the recording medium in a nozzle surface 11 facing the recording medium M. Each unit head 12 has nozzles for ejecting the treatment liquid or the ink jet ink composition, and the nozzles may be arranged in a row. A group of nozzles arranged in a row is also referred to as a “nozzle row.” The recording medium M is transported in the transport direction while being supported by a belt B. The belt B is moved in a transport direction D1 by a belt roller 20. The recording apparatus may include a paper feed tray, a paper discharge tray, and the like (not shown).

The unit head 12 may have such a nozzle row, and the structure or the like is not limited except that the unit head 12 has a nozzle row. A portion of the line head 10 in which one nozzle row exists is one unit head 12. It can also be said that the nozzle row is the unit head 12.

In a line method using a line head, an ink jet head having a width equal to or more than the recording width of the recording medium is fixed to the recording apparatus, for example. An image is then recorded on the recording medium by moving the recording medium along the scanning direction (longitudinal direction of the recording medium, transport direction), and performing scanning to eject ink droplets from the nozzles of the ink jet head in conjunction with this movement.

Alternatively, the recording medium is fixed to the recording apparatus. An image is then recorded on the recording medium by moving the ink jet head having a width equal to or greater than the recording width of the recording medium along the scanning direction, and performing scanning to eject ink droplets from the nozzles of the ink jet head in conjunction with this movement. The scanning direction is the direction of scanning.

Since recording can be performed by one-pass scanning of the line head and the recording medium in such a line method using the line head, the printing speed can be improved.

When printing is performed by a recording apparatus including a line type ink jet head, a printing surface expands, and thus curling (primary curling) may occur immediately after printing. Furthermore, when drying progresses, curling (secondary curling) may occur in ten and several seconds to several minutes due to the influence of the reformation of hydrogen bonds of the recording medium.

However, by using the treatment liquid described above, in a case where drying progresses after printing, it is possible to suppress the reformation of hydrogen bonds or to cause the reformation to progress slowly, and thus it is possible to reduce primary curling and/or secondary curling. The mechanism of curling will be further described later.

In the above description, an example of a case where a line type ink jet head is used has been described, but the recording method according to the present embodiment may be performed by a printer (serial printer) using a serial type ink jet head. In a serial printer, printing is performed by moving an ink jet head in a direction intersecting a transport direction while transporting a recording medium in the transport direction. Even in the case of a serial printer, primary curling and/or secondary curling can be suppressed by using the treatment liquid described above.

### 4. Examples and Comparative Examples

The present disclosure will be specifically described with reference to Examples and the like below, but the present disclosure is not limited to these Examples. Hereinafter, “part” and “%” are based on mass unless otherwise specified. Evaluation is performed in an environment at a temperature of 25° C. and a relative humidity of 40.0% unless otherwise specified.

### 4.1. Preparation of Treatment Liquid

Each component is put into a mixing tank so as to achieve the composition described in Tables 1 and 2, mixed and stirred, and further filtered with a membrane filter to obtain a treatment liquid of each example. Note that the numerical value of each component shown in each example in the tables is represented in terms of mass % unless otherwise described.

The details of the abbreviations and product components used in Tables 1 and 2 are as follows.
Sugar alcohol 1: PO-500 (a mixture of various sugar alcohols which are solid as a simple substance at normal temperature) from Mitsubishi Corporation Life Sciences Limited
Sugar alcohol 2: PO-20 (a mixture of various sugar alcohols which are solid as a simple substance at normal temperature) from Mitsubishi Corporation Life Sciences Limited
Sugar alcohol 3: xylitol
Sugar alcohol 4: sorbitol
OLFINE E1010: acetylene-based surfactant (manufactured by Nissin Chemical Industry Co., Ltd)
OLFINE E1004: acetylene-based surfactant (manufactured by Nissin Chemical Industry Co., Ltd)

In Tables 1 and 2, the moisturizing factors of some components (mass change ratios of a 50 mass % aqueous solution after being allowed to stand at 25° C. and 95% RH for 7 days) are shown. The moisturizing factors are determined as follows. One milliliter of a 50 mass % aqueous solution of each component is put into NEOMINI CUP No. 5 (volume: 5 ml, inner mouth diameter: no flange, 25.2 mm) manufactured by Maruemu Corporation. Then, a value obtained by dividing the mass (mass of the aqueous solution) after being allowed to stand at 25° C. and 95% RH for 7 days by the mass (mass of the aqueous solution) before the standing is defined as the moisturizing factor (mass change ratio (%)). The moisturizing factors are shown in the table.

### 4.2. Evaluation Method

### 4.2. 1. Primary Curling

A modified machine of LX-10050 (line ink jet printer) manufactured by Seiko Epson Corporation is filled with the treatment liquid and the ink of each example, and a solid pattern is printed at duty of 100% for each treatment liquid ink on a recording medium (A4-size Xerox P paper, copy paper manufactured by Fuji Xerox Co., Ltd., basis weight: 64 g/m², paper thickness: 88 μm) at 100 ppm in a face-up manner in an environment of a temperature of 25° C. and a humidity of 50%. Immediately after printing, the angle between the point where the paper and the floor surface are placed and the edge of the paper is measured and evaluated as an index of primary curling.

As the ink, Bk ink for LX-10050 (manufactured by Seiko Epson Corporation) is used, and the line head is disposed so that the treatment liquid and the ink are attached to the recording medium in this order. The duty of 100% is 4.5 mg/inch².

Evaluation is made according to the following criteria, and results are shown in the tables.
A: less than 45°
B: 45° or more and less than 90°
C: 90° or more

### 4.2. 2. Secondary Curling

A modified machine of LX-10050 (line ink jet printer) manufactured by Seiko Epson Corporation prepared in the same manner is filled with the treatment liquid and the ink of each example, and a solid pattern is printed at duty of 100% for each treatment liquid ink on a recording medium (A4-size Xerox P paper, copy paper manufactured by Fuji Xerox Co., Ltd., basis weight: 64 g/m², paper thickness: 88 μm) at 100 ppm in a face-up manner in an environment of a temperature of 25° C. and a humidity of 50%. Then, the amount of lifting of the edge of the paper from the floor surface when the paper is allowed to stand face-up for one week after printing is measured. Evaluation is made according to the following criteria, and results are shown in tables.
A: less than 10 cm
B: 10 cm or more and less than 20 cm
C: 20 cm or more

### 4.2. 3. Color Development (OD)

A modified machine of LX-10050 (line ink jet printer) manufactured by Seiko Epson Corporation prepared in the same manner is filled with the treatment liquid and the ink of each example, and a solid pattern is printed at duty of 100% for each treatment liquid ink on a recording medium (A4-size business plain paper IJ, copy paper manufactured by Seiko Epson Corporation) at 100 ppm. Color development (OD) upon printing is measured. Evaluation is made according to the following criteria, and results are shown in tables.
A: OD is 1.53 or more
B: OD is less than 1.53 and 1.46 or more
C: OD is less than 1.46

### 4.2. 4. Ejection Stability

A cartridge of a modified machine of LX-10050 (line ink jet printer) manufactured by Seiko Epson Corporation prepared in the same manner is filled with the treatment liquid of each example, a test pattern is continuously printed on 30 sheets of A4-size paper after confirming that the treatment liquid is ejected from a plurality of nozzles for one ink communicating with the cartridge, and nozzle checking is performed after printing 30 sheets to evaluate ejection characteristics. Evaluation is made according to the following criteria, and results are shown in tables.
A: there are no unstably ejecting nozzles
B: there are five or less non-ejecting or misdirecting nozzles, which are recovered by cleaning once
C: there are ten or less non-ejecting or misdirecting nozzles, which are recovered by cleaning two or more times

### 4.3. Evaluation Results

As shown in Tables 1 and 2, the treatment liquid of each of Examples, containing an aggregating agent and a sugar alcohol that is solid as a simple substance at normal temperature, in which when a 50 mass % aqueous solution of the sugar alcohol that is solid as a simple substance at normal temperature and that is contained in the treatment liquid is allowed to stand at 25° C. and 95% RH for 7 days, the mass change ratio before and after standing (after standing/before standing) is 120% or less, is excellent in suppression of curling of the recorded material. Further, color development and ejection stability are also good. On the other hand, in Comparative Examples, which do not satisfy the above conditions, curling suppression of the recorded material is poor.

The present disclosure includes a configuration substantially the same as the configuration described in the embodiment, for example, a configuration having the same function, method, and result, or a configuration having the same purpose and effect. Further, the present disclosure includes configurations in which non-essential portions of the configuration described in the embodiment are replaced. In addition, the present disclosure includes configurations that provide the same operations and effects as the configurations described in the embodiment or includes configurations that can achieve the same purpose as the configurations described in the embodiment. Further, the present disclosure includes configurations in which a known technology is added to the configurations described in the embodiment.

The following contents are derived from the above-described embodiment and modifications.

A treatment liquid is an aqueous treatment liquid to be used for recording on a recording medium that is an absorbent recording medium together with an ink jet ink composition containing a coloring material, the treatment liquid containing an aggregating agent and a sugar alcohol that is solid as a simple substance at normal temperature, in which when a 50 mass % aqueous solution of the sugar alcohol that is solid as a simple substance at normal temperature and that is contained in the treatment liquid is allowed to stand at 25° C. and 95% RH for 7 days, a mass change ratio before and after standing (after standing/before standing) is 120% or less.

This treatment liquid allows curling of the recording medium to be suppressed.

In the treatment liquid described above, the content of the sugar alcohol that is solid as a simple substance at normal temperature may be 1% by mass or more and 5% by mass or less based on the total amount of the treatment liquid.

This treatment liquid allows curling of the recording medium to be further suppressed.

In the treatment liquid described above, the aggregating agent may be a polyvalent metal salt.

This treatment liquid allows color development of the ink jet ink composition to be further improved.

In the treatment liquid described above, the aggregating agent may be a calcium salt.

This treatment liquid allows color development of the ink jet ink composition to be further improved.

The treatment liquid described above may further contain a betaine.

This treatment liquid allows secondary curling to be further suppressed.

The treatment liquid described above may further contain a 1,2-alkanediol having 5 or more carbon atoms.

This treatment liquid exhibits further improved spreadability on the recording medium, allows the aggregating agent to be more uniformly attached, and allows the color developability of the ink jet ink composition to be further improved. In addition, the ejection stability of the treatment liquid can also be made more excellent.

The treatment liquid described above may be ejected from an ink jet head, attached to the recording medium, and used for the recording.

This treatment liquid allows the amount of the treatment liquid used in recording to be suppressed.

An ink set includes any one of the treatment liquids described above and an ink jet ink composition.

This ink set allows a recorded material in which curling of the recording medium is suppressed to be formed.

A recording method is performed using any one of the treatment liquids described above and an ink jet ink composition, and includes attaching the treatment liquid to a recording medium that is an absorbent recording medium, and ejecting the ink jet ink composition from an ink jet head to attach the ink jet ink composition to the recording medium.

This recording method allows a recorded material with little curling to be obtained.

In the recording method described above, in the attaching the treatment liquid, the treatment liquid may be ejected from a line type ink jet head as the ink jet head and attached to the recording medium through scanning once.

This recording method allows a recorded material in which curling is suppressed to be obtained even in a situation in which curling easily occurs, and thus allows, for example, recorded materials to be stacked well after recording.

What is claimed is:

1. An aqueous treatment liquid to be used for recording on a recording medium that is an absorbent recording medium together with an ink jet ink composition containing a coloring material, the treatment liquid comprising:
an aggregating agent; and
a sugar alcohol that is solid as a simple substance at normal temperature, wherein
when a 50 mass % aqueous solution of the sugar alcohol that is solid as a simple substance at normal temperature and that is contained in the treatment liquid is allowed to stand at 25° C. and 95% RH for 7 days, a mass change ratio before and after standing (after standing/before standing) is 120% or less.

2. The treatment liquid according to claim 1, wherein
a content of the sugar alcohol that is solid as a simple substance at normal temperature is 1% by mass or more and 5% by mass or less based on a total amount of the treatment liquid.

3. The treatment liquid according to claim 1, wherein
the aggregating agent is a polyvalent metal salt.

4. The treatment liquid according to claim 3, wherein
the aggregating agent is a calcium salt.

5. The treatment liquid according to claim 1, further comprising:
a betaine.

6. The treatment liquid according to claim 1, further comprising:
a 1,2-alkanediol having 5 or more carbon atoms.

7. The treatment liquid according to claim 1, which is ejected from an ink jet head, attached to the recording medium, and used for the recording.

8. An ink set, comprising:
the treatment liquid according to claim 1; and
an ink jet ink composition.

9. A recording method to be performed using the treatment liquid according to claim 1 and an ink jet ink composition, the method comprising:
attaching the treatment liquid to a recording medium that is an absorbent recording medium; and
ejecting the ink jet ink composition from an ink jet head to attach the ink jet ink composition to the recording medium.

10. The recording method according to claim 9, wherein
in the attaching the treatment liquid, the treatment liquid is ejected from a line type ink jet head as the ink jet head and attached to the recording medium through scanning once.
